(19) United States
(12) Patent Application Publication
(10) Pub. No.: US 2026/0338336 A1
(43) Pub. Date: Oct. 29, 2026

(54) RESTRAINT MECHANISM FOR RECESSED LIGHT FIXTURES

(71) Applicant: SIGNIFY HOLDING B.V., EINDHOVEN (NL)

(72) Inventors: WEI ZHAO, SHANGHAI (CN); RUSSELL BRYANT GREEN, DOUGLASVILLE, GA (US); ZHIHONG LIN, SHANGHAI (CN); JARED MICHAEL DAVIS, NEWNAN, GA (US)

(21) Appl. No.: 19/099,167

(22) PCT Filed: Aug. 8, 2023
(86) PCT No.: PCT/EP2023/071882

§ 371 Date: Jan. 28, 2025

(30) Foreign Application Priority Data
Aug. 26, 2022 (EP) 22192467.3

(51) Int. Cl. F21S 8/02; F21V 21/04; F21V 29/74

(52) U.S. Cl. CPC F21S 8/026; F21V 21/044; F21V 29/74

(57) ABSTRACT

A recessed lighting fixture (100) is disclosed that includes a light module (101) that includes a light source, a heat sink (200) thermally coupled to the light module (101), the heat sink including one or more embossments (207); and a trim assembly (300). The trim assembly (300) can be removably coupled to the light module (100). The trim assembly (300) includes a top edge (302) defining a first opening and a bottom edge (303) defining a second opening that is disposed below the first opening, a body (305) extending from the top edge (302) to the bottom edge (303), and a retention assembly (400). The retention assembly (400) includes a tension spring (402), one or more arms (401) extending from the tension spring (402) and one or more tab brackets (404). When the trim assembly is mechanically coupled to the light module the one or more tabs brackets (404) mate with the one or more embossments (207) on the heat sink (200) and the one or more tabs brackets (404) lock into place when the one or more arms (401) extending from the torsion spring (402) are biased outwards toward the bottom edge (303) of the trim (300) in the mounting position, the lighting fixture (100) is held in place to reduce or prevent any rotation or shifting. The one or more arms (401) extending from the torsion spring (402) are biased outwards toward the bottom edge (303) and act like mouse trap spring to removable hold the lighting fixture (100) in a mounting position.

### FIELD OF THE INVENTION

The invention relates generally to recessed lighting fixtures, and in particular, to a mechanism for stably securing recessed lighting fixtures in a mounting location.

### BACKGROUND

Recessed light fixtures are usually provided with a trim assembly which surround the outer edge of the recessed light housing to hide any imperfections about the hole formed in the sheeting material into which the recessed light fixture is mounted. In such conventional recessed lighting fixtures, the light fixture and trim assembly are held loosely in place by one or more torsion brackets and wire arms that are fastened to the trim assembly as shown in FIG. 6.

However, problems may occur when the trim assembly is held in place by nothing other than friction using the tension brackets and wire arms. This may leave the trim assembly and light fixture to gradually drop from vibration, rotate out of proper alignment or not be held stably secure in the mounting location.

### SUMMARY OF THE PRESENT INVENTION

Aspects, objects, and embodiments of the present invention address the shortcomings discussed above.

In this regard, one aspect of the present invention allows for the ability to stability secure a recessed lighting fixture to a mounting location so as to reduce the possibility of displacement or rotation out of proper alignment.

Another aspect of the present invention allows for an improved method for installing a recessed lighting fixture.

Yet another aspect of the present invention allows for a tension force used to mount/secure a recessed lighting fixture in a mounting location to be spread in a manner to reduce the risk of deforming the trim assembly of the lighting fixture.

One embodiment of the present invention is directed to a recessed lighting fixture that includes a light module that includes a light source, a heat sink thermally coupled to the light module, and a trim assembly. The heat sink includes one or more embossments; The trim assembly can be removably coupled to the light module. The trim assembly includes a top edge defining a first opening and a bottom edge defining a second opening that is disposed below the first opening, a body extending from the top edge to the bottom edge, and a retention assembly. The retention assembly includes a tension spring, one or more arms extending from the tension spring and one or more tab brackets. When the trim assembly is mechanically coupled to the light module the tabs brackets mate with the embossments. The arms extending from the torsion spring are biased outwards toward the bottom edge and act like mouse trap spring to removable hold the lighting fixture in a mounting position.

Another embodiment of the present invention is directed to a recessed lighting fixture that includes a light module that includes a light source, an enclosure that support the light module, and a trim assembly. The enclosure includes one or more embossments; The trim assembly can be removably coupled to the light module. The trim assembly includes a top edge defining a first opening and a bottom edge defining a second opening that is disposed below the first opening, a body extending from the top edge to the bottom edge, and a retention assembly. The retention assembly includes a tension spring, one or more arms extending from the tension spring and one or more tab brackets. When the trim assembly is mechanically coupled to the light module the tabs brackets mate with the embossments. The arms extending from the torsion spring are biased outwards toward the bottom edge and act like mouse trap spring to removable hold the lighting fixture in a mounting position.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIGS. 1a and 1b illustrates perspectives view of an example light-emitting diode based recessed lighting fixture, in accordance with an example embodiment of the present disclosure;

FIG. 2 illustrate a detail of an emboss feature of the example light-emitting diode based recessed lighting fixture of FIG. 1;

FIG. 3 illustrates a perspective view of a trim assembly of the example light-emitting diode based recessed lighting fixture of FIG. 1, in accordance with an example embodiment of the present disclosure;

FIG. 4 illustrates a detail of a retention assembly of the trim assembly of FIG. 1; and

FIG. 5 illustrate a detail of the emboss feature of FIG. 2 engaged with the retention assembly of FIG. 4;

FIG. 6 illustrates a prior art the light fixture and trim assembly.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

In the following paragraphs, the present disclosure will be described in further detail by way of examples with reference to the attached drawings. In the description, well known components, methods, and/or processing techniques are omitted or briefly described so as not to obscure the disclosure. As used herein, the “present disclosure” and/or “present invention” refers to any one of the embodiments of the disclosure described herein and any equivalents. Furthermore, reference to various feature(s) of the “present disclosure” is not to suggest that all embodiments must include the referenced feature(s).

The present disclosure is directed to an example lighting fixture such as a light-emitting diode (LED) based recessed lighting fixture (or “lighting unit”) that includes a light module and a trim assembly that maybe removably coupled to the light module. The trim assembly of the present disclosure may include a trim and optical devices, i.e., an upper reflector and a lens, that are captive on the trim for shaping light from the light module into desired beam angles. In particular, the upper reflector is attached to the trim using a plurality of tabs that snap into corresponding cut outs or through slots in the trim such that the lens (specifically, a collar of the lens) is disposed in between the upper reflector and the trim. Further, the trim assembly includes a retention assembly spring that can be mounted on the trim for installing the recessed lighting fixture into a mounting position/location, e.g., in a ceiling.

In the present disclosure, the light module may include a die-cast housing which includes a connector part and a heat sink part. Further, the light module includes a wire cover member that is coupled to the die-cast housing. Furthermore, the light module includes a light source that is disposed between the wire cover member and the die-cast housing. Particularly, the light source is coupled to the heat sink part of the die-cast housing such that the heat sink part dissipates heat that is generated from a light source of the recessed lighting fixture. In one example, the light source may be an LED, however, one of ordinary skill in the art can understand and appreciate that any other type of point or non-point light source may be used in the recessed lighting fixture described herein without departing from a broader scope of the present disclosure. Additionally, the light module includes one or more connector receptacles that provide a connection point for external power sources to connect to the light module and power the light source. In particular, the one or more connector receptacles are supported by the wire cover member and are disposed in the connector part of the die-cast housing.

The technology of the present disclosure can be embodied in many different forms and should not be construed as limited to the embodiments set forth herein; rather, these embodiments are provided so that this disclosure will be thorough and complete, and will fully convey the scope of the technology to those having ordinary skill in the art. Furthermore, all “examples” or “example embodiments” given herein are intended to be non-limiting and among others supported by representations of the present technology.

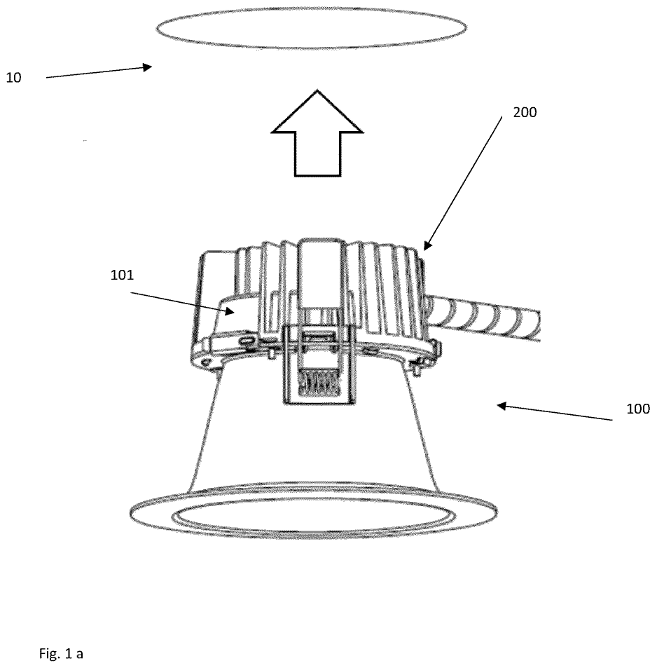

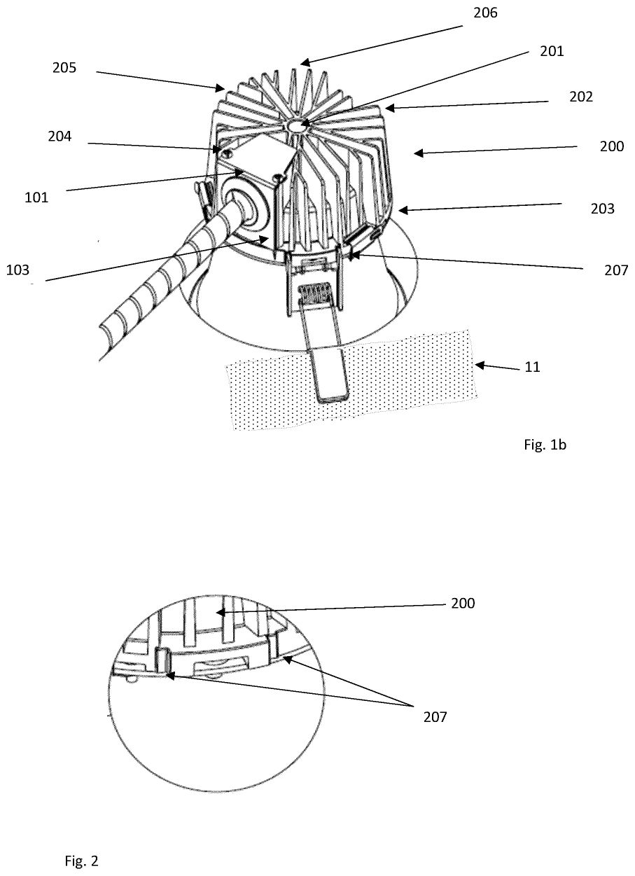

As illustrated in FIGS. 1a and 1b, a recessed lighting fixture 100 includes a light module 101 and a heat sink 200 that is thermally coupled to the light module 101. One of ordinary skill in the art can understand and appreciate that in some example embodiments, the heat sink 200 may be designed in different configurations depending on the lumen output of the light module 101 or the heat sink 200 may not include depending on the lumen output of the light module 101 or the drive current used to power a light source of the light module 101. Instead, an enclosure 103 of the light module 101 may act as the heat sink for light modules that have low lumen output. However, light modules that have medium or high lumen output may use the heat sinks 200. The heat sink 200 may be a dedicated structure that provides additional surface area for dissipating the heat (which increases proportionally with the lumen output of the light modules) generated by the light source of the light module 101.

In certain example embodiments, the heat sink 200 may be an extruded metal, such as aluminum, that allows the height of the of the heat sink 200 to be easily increased for use with different light modules based on the lumen output of the light modules. However, in other example embodiments, the heat sink 200 may be formed using any other appropriate manufacturing process without departing from a broader scope of the present disclosure.

As illustrated in FIG. 1b, the heat sink 200 may include an elongated center body 201 that extends from a top end 202 to a bottom end 203. In particular, the elongated center body 201 may be defined by a module cavity 204 that may support the lighting module 101 on one side and a substantially cylindrical surface 205 (spanning equal to or more than 180 degrees) on the opposite side. Further, the heat sink 200 may include a plurality of fins 206 that extend radially outwards from the cylindrical surface 205 and from the top end 202 to the bottom end 203 of the heat sink 200. It will be understood by one of ordinary skill that the fins 206 of the heat sink 200 may have other shape without departing from a broader scope of the present disclosure.

As shown in more detail in FIG. 2, the heat sink 200 includes one or more embossments 207. The one or more embossments 207 form a relief that can receive a mating object, While two embossments 207 are shown in FIG. 2, other number of embossments 207 can be used in accordance with embodiments of the present invention. In addition, while the embossments 207 are shown having a rectangular in shape in the embodiment of FIG. 2, it will be appreciated that any other shapes such as half circular or triangular shapes may be used. It should also be understood that if no heat sink 200 is provided in the lighting fixture 100 then the enclosure 103 may include the one or more embossments 207 in place of the heat sink 200. Alternatively, the one or more embossments 207 may be included as part of other suitable housing hardware of the lighting fixture 100.

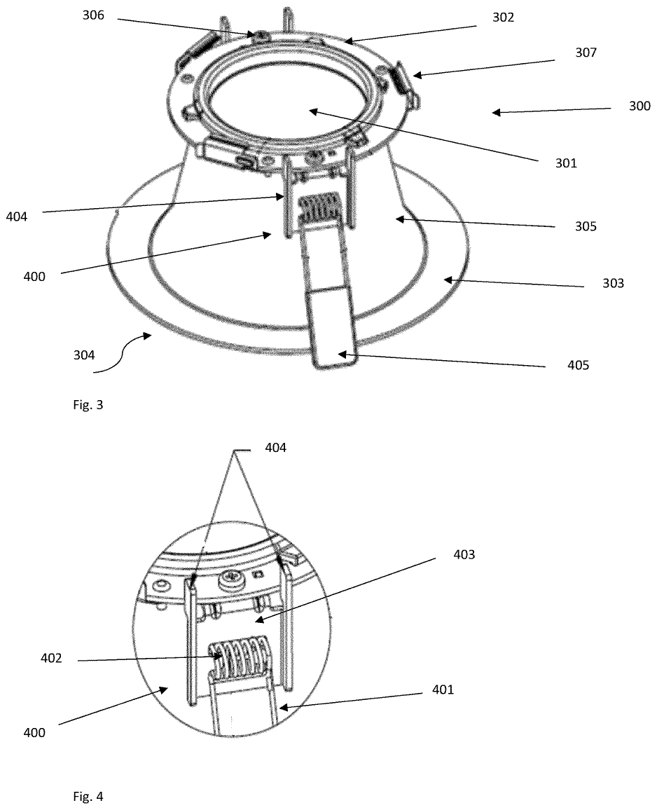

Referring now to FIG. 3, a trim assembly 300 includes a top aperture 301 defined by a top edge 302, a bottom edge 303 that defines a light exit opening 304, and a trim body 305 that extends from the top edge 302 to the bottom edge 303. The diameter of the top edge 302 may be smaller than that of the bottom edge 303. However, in other example embodiments, the diameter of the top edge 302 may be substantially similar to or greater than that of the bottom edge 303. The top edge 301 may also include a first set of through apertures that are configured to couple one or more retention assemblies 400 to the trim 300 using fasteners, such as screws 306. Further, the top edge 302 may also include a second set of through apertures configured to couple one or more coupling clips 307 to the trim 300 using fasteners, such as rivets or screws 308. The coupling clips 307 are used to mechanically couple the trim 300 to the lighting fixture 100. It will be understood by one of ordinary skill that other means may be used to mechanically couple the trim 300 to the lighting fixture 100 such as rivets, screws, clamps and adhesives.

Referring to FIG. 4 the retention assembly 400 includes one or more arms 401 extending from a helical wire section forming a torsion spring 402 retained in a support structure 403 held to the trim 300 by the fastener 306. The one or more arms 401 extending from the torsion spring 402 are biased outwards toward the bottom edge 303 of the trim 300. As shown in the example embodiment of FIG. 4, two arms 401 are interconnected at their ends by an abutment pad formation 405 secured across free ends of the one or more arms 401 as shown in FIG. 2. The support structure 403 also include one or more tab brackets 404 formed by walls extending from the support structure 403. In other embodiments, the tab brackets 404 may be formed integral with the trim 300. In other embodiments, the tab brackets 404 may have other configuration such as a bulge or bump extending up from the support structure 403. As described below, the one or more tab brackets 404 mate with the one or more embossments 207.

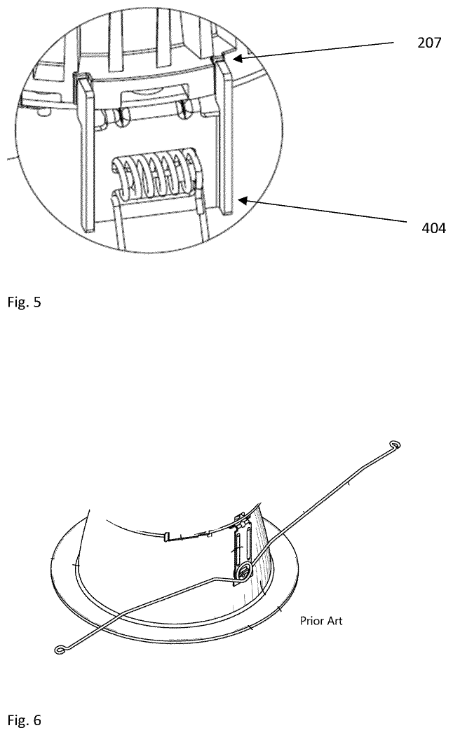

For example, as shown in FIG. 5, two tabs 404 brackets mate/fit into two embossments 207 which lock into place when the one or more arms 401 extending from the torsion spring 402 are biased outwards toward the bottom edge 303 of the trim 300 in the mounting position. For example, the two tabs 404 brackets are pushed or deformed to mate/fit into the two embossments 207 via the tension force of the biased torsion spring 402 when the light fixture is installed into a ceiling. This feature prevents the retention assembly 400 from rotating or shifting. This also allow the tension force from the torsion spring 402 to be spread via the tab brackets 404 to heatsink 200. This prevents or reduces the possibility of the tension force from deforming the trim 300.

As shown in this embodiment, the retention assembly 400, which acts similar to a mouse trap spring bracket, may removable couple the lighting fixture 100 to a mount surface/location, such as in a ceiling. In this regard, FIG. 1a shows the retention assembly 400 with the one or more arms 401 forced toward the top edge 302 so that the lighting fixture 100 may be inserted in a recess 10 such as in a ceiling. FIG. 1b shows the lighting assembly 100 after insertion in the recess 10 and the one or more arms 401 released from the up position toward the top edge 302 so that the one or more arms 401 exert pressure on a mount surface/location to secure the lighting fixture 100 in place. In this regard, the bottom edge 304 of the trim 300 has an upward pressure due to the bias of the torsion spring 402 and the one or more arms 401 pressing downward on a sheeting material 11 of the mounting location toward the bottom edge 304.

In more detail, the installation of the lighting fixture 100 is simple and quickly accomplished by simply displacing the one or more arms 401 from a downward biased position, as shown in Fig. la, to an outward and upright position for insertion of the wire arms 45 with their abutment pad formations 46 into the recess 10 (e.g., a ceiling hole) and releasing the one or more arms 401 while pushing the lighting fixture 100 into the recess 10 wherein when released the one or more arms 401 will automatically displace downwards by the force of the torsion spring 402 placing their abutment pad formation 405 towards and holding the lighting fixture 100 in place. As the lighting fixture 100 is pushed in the recess 10, the abutment pad formations 405 apply an inner pulling force on the lighting fixture 100. The torsion spring 402 has a torsion force of a strength adequate to apply an inward retention force to maintain a retention force on the bottom edge 304.

Accordingly, the retention assembly 400 with the embossments 207 make installation of the lighting fixture 100 easier and allows the lighting fixture 100 to be stably secured in place to prevent/reduce any vertical or horizonal movement.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components (devices, systems, and the like), the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

In the claims references in parentheses refer to reference signs in drawings of exemplifying embodiments or to formulas of embodiments, thus increasing the intelligibility of the claim. These references shall not be construed as limiting the claim.

1. A recessed lighting fixture comprising:
a light module that includes a light source;
a heat sink thermally coupled to the light module the heat sink including one or more embossments and
a trim assembly that is removably coupled to the light module the trim assembly including a top edge defining a first opening and a bottom edge defining a second opening that is disposed below the first opening, a body extending from the top edge to the bottom edge, and a retention assembly including a tension spring one or more arms extending form the tension spring and one or more tab brackets,
wherein when the trim assembly is mechanically coupled to the light module the one or more tabs brackets mate with the one or more embossments on the heat sink and the one or more tabs brackets lock into place when the one or more arms extending from the torsion spring are biased outwards toward the bottom edge of the trim in the mounting position, the lighting fixture is held in place to reduce or prevent any rotation or shifting.

2. The recessed lighting fixture of claim 1, wherein the one or more tab brackets are formed by walls extending in a vertical orientation toward the top edge

3. The recessed lighting fixture of claim 1, wherein the one or more embossments are rectangular in shape.

4. The recessed lighting fixture of claim 1, wherein retention assembly include two tab brackets and the heat sink includes two embossments wherein the two tab brackets mate into the two embossments

5. The recessed lighting fixture of claim 4, wherein the retention assembly includes two arms extending from the torsion spring that are biased outwards toward the bottom edge which act like mouse trap spring to removable hold the lighting fixture to a mounting position wherein the torsion spring has a torsion force of a strength adequate to apply an inward retention force to maintain a retention force on the bottom edge.

6. The recessed lighting fixture of claim 5, wherein the torsion force from the torsion springing is spread via the two tab brackets to the heat sink to reduce the possibility of the tension force from deforming the trim.

7. The recessed lighting fixture of claim 5, wherein the two arms are interconnected at ends opposite the torsion spring by a pad secured across free ends of the two arms

8. The recessed lighting fixture of claim 1, wherein the trim further includes one or more coupling clips that mechanically couple the trim to the lighting fixture

9. A recessed lighting fixture comprising:
a light module that includes a light source;
an enclosure that supports the light module including one or more embossments and
a trim assembly that is removably coupled to the light module the trim assembly including a top edge defining a first opening and a bottom edge defining a second opening that is disposed below the first opening, a body extending from the top edge to the bottom edge, and a retention assembly including a tension spring one or more arms extending form the tension spring and one or more tab brackets,
wherein when the trim assembly is mechanically coupled to the light module the one or more tabs brackets mate with the one or more embossments on the enclosure and the one or more tabs brackets lock into place when the one or more arms extending from the torsion spring are biased outwards toward the bottom edge of the trim in the mounting position, the lighting fixture is held in place to reduce or prevent any rotation or shifting.

10. The recessed lighting fixture of claim 9, wherein the one or more tab brackets are formed by walls extending in a vertical orientation toward the top edge

11. The recessed lighting fixture of claim 9, wherein the one or more embossments are rectangular in shape.

12. The recessed lighting fixture of claim 9, wherein retention assembly include two tab brackets and the heat sink includes two embossments wherein the two tab brackets mate into the two embossments.

13. The recessed lighting fixture of claim 12, wherein the retention assembly includes two arms extending from the torsion spring that are biased outwards toward the bottom edge which act like mouse trap spring to removable hold the lighting fixture to a mounting position wherein the torsion spring has a torsion force of a strength adequate to apply an inward retention force to maintain a retention force on the bottom edge.

14. The recessed lighting fixture of claim 12, wherein the torsion force from the torsion spring is spread via the two tab brackets to the heat sink to prevent or reduce the possibility of the tension force from deforming the trim.
